(19) United States
(12) Patent Application Publication
(10) Pub. No.: US 2004/0153546 A1
(43) Pub. Date: Aug. 5, 2004

(54) Generic network interface function

(76) Inventor: Manfred Leitgeb, Gramatneusiedl (AT)

Correspondence Address: Kevin R. Spivak, Morrison & Foerster LLP, Suite 300, 1650 Tysons Boulevard, McLean, VA, 22102, US

(21) Appl. No.: 10/374,725

(22) Filed: Feb. 27, 2003

(30) Foreign Application Priority Data
Jan. 31, 2003 (DE) 20301512.6

(51) Int. Cl. G06F 15/16

(52) U.S. Cl. 709/227; 709/229

(57) ABSTRACT

A simple and efficient way of connecting services to applications is described by the apparatus and method for connecting services to applications in a communication network, characterized in that an OSA gateway (4) for providing a service sets up an access point between a requesting application (1) and a portal (3) in order to negotiate a transmission protocol, and in that, following successful negotiation, provision of the service in the portal (3) is granted to the application (1) via the OSA gateway (4).

The invention relates to an apparatus and a method for connecting services to applications in a communication network.

Telecommunication networks are continuously being complemented by new components and services. On the one hand these new components replace and improve existing functions and on the other hand these new components provide additional functions. The regulators and operators of the networks therefore strive to provide new services with new network properties. To date, this has been done in a mobile communication network using the “OSA” (Open Service Architecture) approach. With this approach, existing network capabilities are abstracted and are provided by means of an API service. This principle is based on network properties of services first being defined and then the type of services being presented and enabled by the OSA-API service. For unknown network properties which are to be defined afresh, there is no standardized access point to a communication network.

It is an object of the present invention to provide a cost-efficient and easily implemented solution to connecting new services to applications in a communication network.

The invention achieves the object by means of the subject matter covered in the independent claims. Developments of the invention are specified in the subclaims. The essence of the invention is that, first, a service proposes that a processing unit (OSA framework) in an OSA gateway accept parameters of the service and that these parameters, e.g. type of service and address at which the service is available, be stored in a table associated with the OSA gateway, and that, secondly, upon a request from an application for a service, a connection to the service is set up using an interface functionality (generic network interface function) associated with the OSA framework. From the point of view of the application, only the OSA gateway is contacted, i.e. the application does not receive any kind of address at which a service is available in a portal. This makes it possible to ensure protection against unauthorized access to a service.

The invention is explained in more detail with reference to an exemplary embodiment illustrated in the figures, in which, specifically,

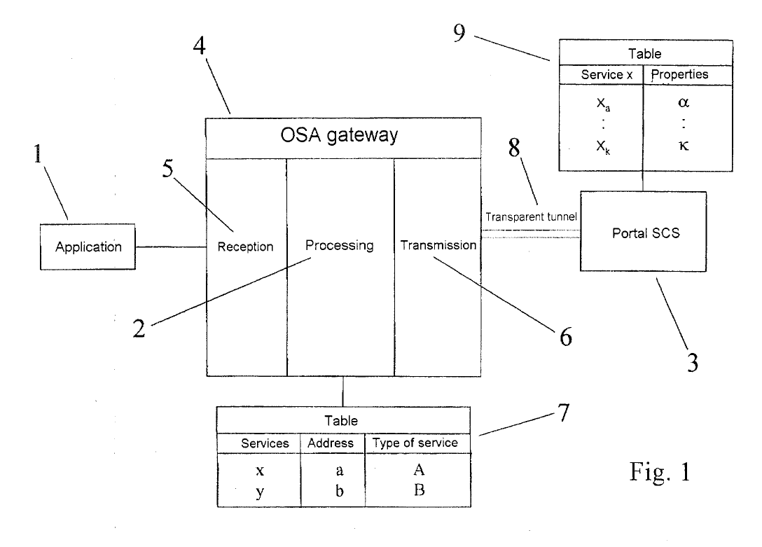

FIG. 1 shows the apparatus for connecting a service to an application in a communication network,

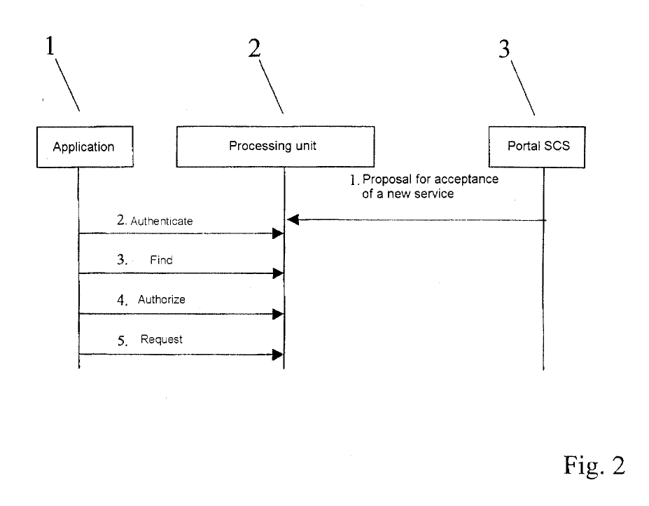

FIG. 2 shows the proposal for acceptance of parameters of a new service and the request regarding connection to a service from the application,

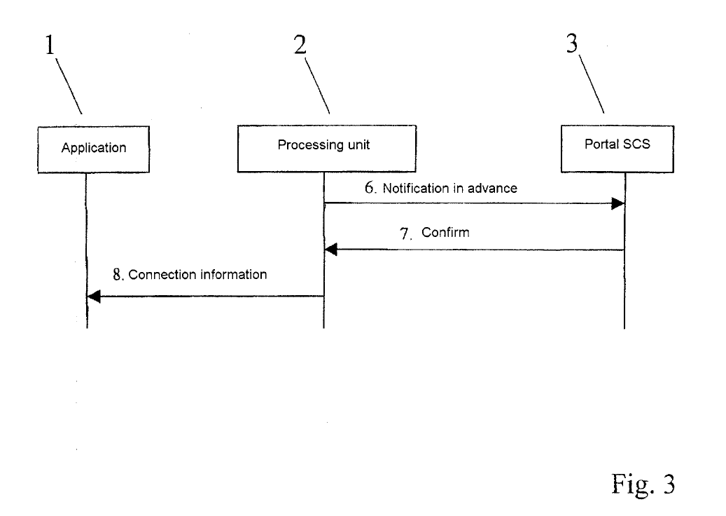

FIG. 3 shows the acceptance of the connection profile, and

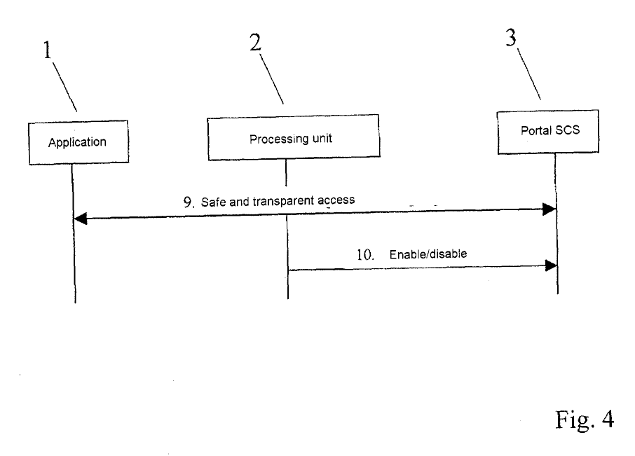

FIG. 4 shows the setup and monitoring of the connection.

FIG. 1 shows the apparatus for connecting a service to an application. If a communication network wishes to implement a new component or a new service, then the service, which is in a table 9 associated with a portal 3, registers with a processing unit 2 in the OSA gateway 4, the OSA framework 2, and is thus known to the OSA framework 2. The service registers by proposing that parameters, e.g. type of service and address at which the service is available in a table 9 associated with the portal 3, be accepted via a reception unit 5 into a table 7 associated with the OSA gateway 4. The OSA framework 2 is part of an OSA gateway 4 with an interface functionality (generic network interface function) and is responsible for the authorization, authentication and data integrity of a connection. The OSA framework 2 thus has knowledge only of the type of service, such as whether the service is responsible for location information, a messaging server, etc., and the address at which the service is available in a table 9 associated with the portal 3, but it (2) has no knowledge of how this service can be addressed, i.e. used. If an application 1 wishes to use the service, the OSA gateway 4 uses a transmission unit 6 to set up a secure access point, a transparent tunnel 8, to a service in a table 9 associated with a portal 3. In this case, a transparent tunnel is a path from the application 1 through the OSA gateway 4 to the portal 3, with the OSA gateway 4 having no information about the content of the data which are transmitted. A connection is thus used which is in a form such that the OSA gateway 4 does not need to have any information about the data being transmitted. The path via the OSA gateway 4 is merely for safety reasons, because, if the OSA gateway 4 also has no information about the content of the data transmitted, it (4) can still “disable” the path and hence interrupt the connection between the application 1 and the portal 3. The service then notifies the application 1 of the details of the provided interface using the reception unit, the OSA framework 2 and the transmission unit 6, and the protocol to be used is negotiated between the application 1 and the service in a table 9 associated with the portal 3. If the result of negotiation is successful, the application 1 can set up a connection to the service and can thus use the service. The connection between the application and the service is made exclusively via the OSA framework 2 associated with the OSA gateway 4. A generic network interface function in an OSA framework 2 handles the requests and responses from the application 1 and the service transparently. From the point of view of the application, this means that it communicates only with the OSA gateway, and the address at which the service is available in a table 9 associated with the portal 3 is never disclosed to the application 1. This makes it possible to protect the service against unauthorized access.

FIG. 2 shows how a service in a portal 3 makes a proposal for acceptance. The parameters, e.g. the type of service and the address at which the service is available in a table 9 associated with the portal 3, are in this case entered into a table 7 associated with the OSA gateway 4. This means that the service is available to an application 1 via a generic network interface function in an OSA framework 2. A generic network interface function in an OSA framework 2 handles the requests and responses from the application 1 and the service transparently. From the point of view of the application, this means that it communicates only with the OSA gateway, and the address at which the service is available in a table 9 associated with the portal 3 is never disclosed to the application 1. To connect to a service, the application 1 authenticates itself with the OSA framework 2 in an OSA gateway 4, finds the desired service in the table 7 and transmits the authorization for the service to the OSA framework 2 via the reception unit 5 associated with the OSA gateway 4. If authorization is successful, the application can now make an access request for the desired service.

FIG. 3 shows how the OSA framework 2 uses a transmission unit 6 to prepare the connection by means of an announcement. To this end, the OSA gateway 4 uses a transmission unit 6 to set up a secure access point, a transparent tunnel 8, to a service in a table 9 associated with a portal 3. The service then notifies the application 1 of the details of the provided interface using the reception unit, the OSA framework 2 and the transmission unit 6, and the protocol to be used is negotiated between the application 1 and the service in a table 9 associated with the portal 3. Conceivable protocols are, by way of example, the dynamic CORBA call interface, XML, SOAP, various applets or Java Beans.

FIG. 4 shows how, in the case of a successful negotiation result, the application 1 can set up a connection to the service and can thus use the service. The connection between the application and the service is made exclusively using the generic network interface function of the OSA framework 2 associated with the OSA gateway 4. In this case, the generic network interface function always makes requests for enabling the connection for the application 1 to the portal 3.

1. An apparatus for connecting services to applications in a communication network,
having a reception unit (5) for receiving a proposal for acceptance of parameters of a service and a request regarding provision of a service from an application (1),
having a processing unit (2) for recording the type of service, and the address at which the service is available in a table (9) associated with the portal (3), in a table (7) and for processing the request regarding to connection to a service from an application,
having a processing unit (2) for checking the request for authentication and authorization, for forwarding the request via a transmission unit (7) and an access point (9) to a service in a portal (3), and for enabling the connection of the service to an application (1) following successful negotiation of a transmission protocol which is to be used between them,
having a portal (3) for disclosing properties of the service from a table (9), and an interface which is to be used, to the application (1) via the OSA gateway (4),
having a portal (3) for negotiating the transmission protocol which is to be used with the application (1) via the OSA gateway (4).

2. The apparatus as claimed in claim 1, characterized
in that the transmission protocol is provided for the connection between the service and the application (1).

3. The apparatus as claimed in claim 1, wherein the transmission protocols provided are a dynamic CORBA call interface, XML, SOAP, applets or Java Beans.

4. The apparatus as claimed in claim 1, wherein the apparatus is provided in a mobile communication network.

5. The apparatus as claimed in claim 1, wherein the apparatus is provided in a computer network.

6. The apparatus as claimed in claim 1, wherein the service access point (8) provided via a portal (3) is a transparent tunnel.

7. A method for connecting services to applications in a communication network, characterized
in that an OSA gateway (4) for providing a service sets up an access point between a requesting application (1) and a portal (3) providing the service in order to negotiate a transmission protocol, and in that, following successful negotiation, provision of the service in the portal (3) is granted to the application (1) via the OSA gateway (4).

8. The method as claimed in claim 7, characterized
in that a service's properties and interface to be used are written to a table (9) associated with the portal (3).

9. The method as claimed in claim 7, wherein, for at least one service, parameters regarding the type and address of the service are written to a table (7).

10. The method as claimed in claim 7, wherein, upon a request from an application (1) regarding provision of a service, the application's authentication and authorization are checked by the OSA gateway (4).

11. The method as claimed in claim 7, wherein, to provide the service, a transparent tunnel (8) is used as a connection between the OSA gateway (4) and the portal (3).
